(19) United States
(12) Patent Application Publication
(10) Pub. No.: US 2010/0140924 A1
(43) Pub. Date: Jun. 10, 2010

(54) APPARATUS FOR PROTECTING A SWIVEL ON A FIRE DEPARTMENT CONNECTION

(76) Inventor: Dohn J. Trempala, Phoenix, AZ (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/634,396

(22) Filed: Dec. 9, 2009

Related U.S. Application Data
(60) Provisional application No. 61/121,484, filed on Dec. 10, 2008.

(51) Int. Cl. F16L 55/00

(52) U.S. Cl. 285/92

(57) ABSTRACT

A swivel protection device comprises an enclosure and a locking plug. The enclosure covers a portion of a swivel of a fire department connection that includes a set plug. The set plug holds the swivel onto the fire department connection. The enclosure covers the set plug such that, when the enclosure is locked over the swivel, access to the set plug is severely limited or excluded.

### RELATED APPLICATIONS

The present application claims the priority benefit under 35 U.S.C. §119(e) of U.S. Provisional Application No. 61/121,484, filed on Dec. 10, 2008, which is hereby incorporated by reference in its entirety.

### BACKGROUND OF THE INVENTION

1. Field of the Invention

The present invention generally relates to devices designed to protect a components of a fire department connection. More particularly, the present invention relates to devices designed to protect swivels that form a part of fire department connections.

2. Description of the Related Art

Fire Department Connections (FDC) 100, such as that shown in FIGS. 1 and 2, are used to supply supplemental water to fire sprinkler systems. In use, the responding fire department connects an outside water source (e.g., afire truck pumper) to the sprinkler system via the FDC with a lay of fire hose.

The hose is attached to the FDC 100 with a threaded coupling 102. With reference to FIGS. 1 and 2, the threaded coupling 102 forms a rotary connector to the FDC 100. The rotary connector is commonly referred to as a swivel. Ball bearings (not shown) can be installed between the rotary connector 102 and the stem of the FDC 100. In the illustrated assembly, the stem each includes a channel 104 that receives the ball bearings. These ball bearings are held in the channel, or coupling race, with an external screw plug or set screw 106.

The swivel 102 typically is made of either brass or aluminum. Due to the high value of scrap brass and aluminum, the swivels 102 have become a target of thieves. Removal of the swivel 102, however, renders the FDC 100 useless and high pressure water cannot be pumped to the sprinkler system once the swivel 102 has been removed.

In addition, vandals have been known to incapacitate fire department connections by banging on the swivel 102 with sufficient force to limit or completely prevent relative rotational movement between the swivel 102 and the stem of the FDC 100. Such attacks on the FDC coupling can render the FDC useless to a responding fire department.

### SUMMARY OF THE INVENTION

Accordingly, certain features, aspects and advantages of the present invention relate to a product to safeguard couplings of fire department connections (FDC) from theft and malicious tampering.

One aspect of an embodiment that is arranged and configured in accordance with certain features, aspects and advantages of the present invention relates to a swivel protection device. The swivel protection device is designed for assembly onto a fire department connection swivel. The device comprises an enclosure and a locking plug. The locking plug is adapted to lock within an opening of the fire department connection. The locking plug has an outside diameter. The enclosure comprises at least one side wall. The at least one side wall is connected to an end wall. The end wall comprises an opening that has a cross dimension that is smaller than the outside diameter of the locking plug.

### BRIEF DESCRIPTION OF THE DRAWINGS

These and other features, aspects and advantages of the present invention will now be described with reference to the drawings of a preferred embodiment, which embodiment is intended to illustrate and not to limit the invention, and in which figures:

FIG. 1 is a perspective view of a wall-type fire department connection having two swivels.

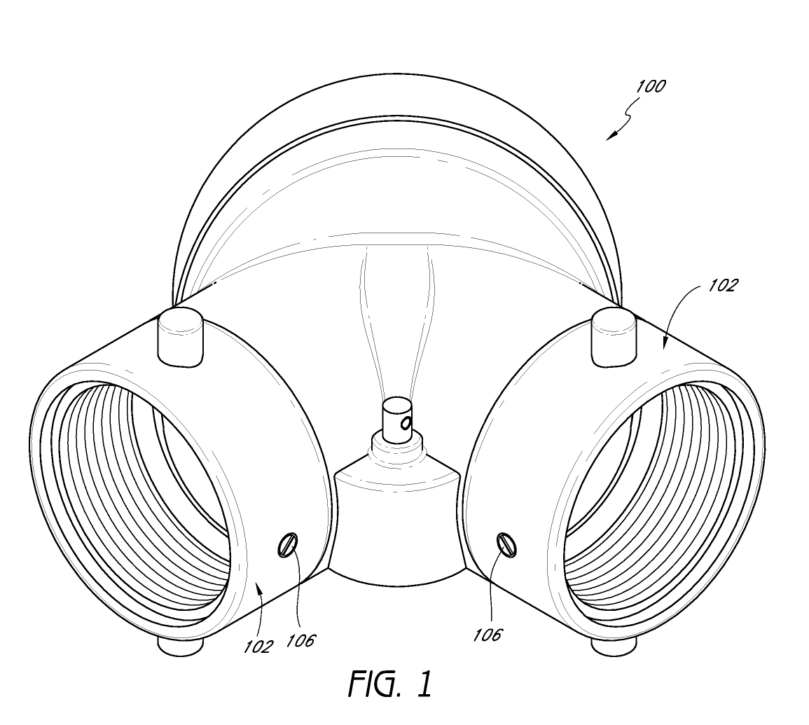

FIG. 2 is a perspective view of the FDC of FIG. 1 with a set screw removed from one of the swivels and one of the swivels shown exploded from the balance of the FDC.

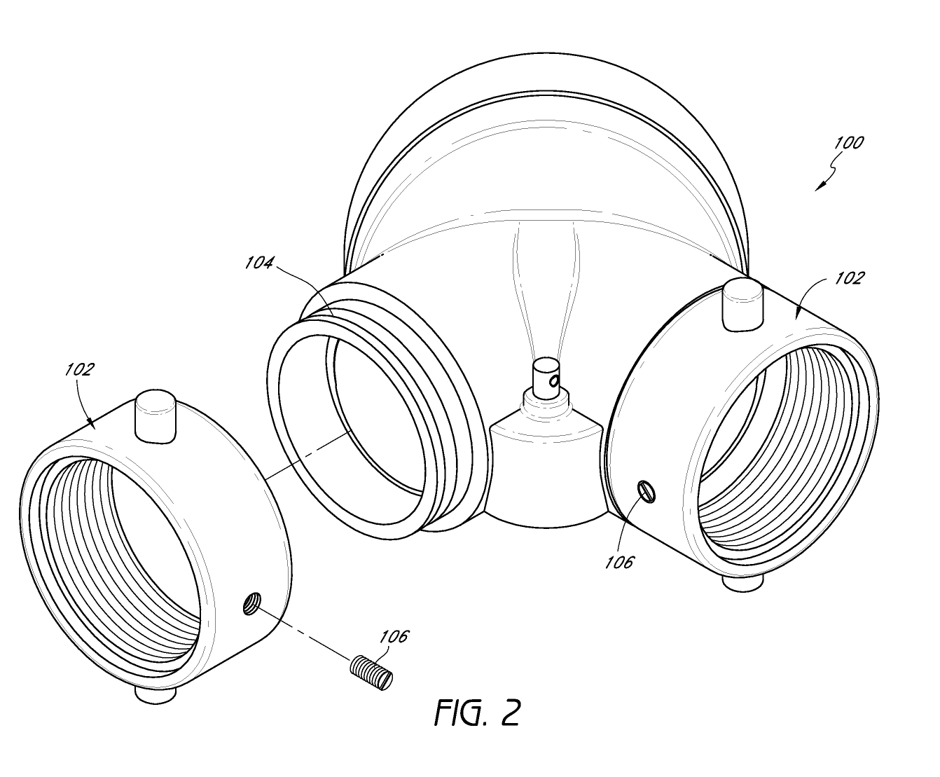

FIG. 3 is a perspective view of the FDC of FIG. 1 with a swivel protection device installed over both swivels.

FIG. 4 is a sectioned view of the swivel protection device of FIG. 3.

FIG. 5 is an exploded view of the swivel protection device of FIG. 3.

### DETAILED DESCRIPTION OF THE PREFERRED EMBODIMENT

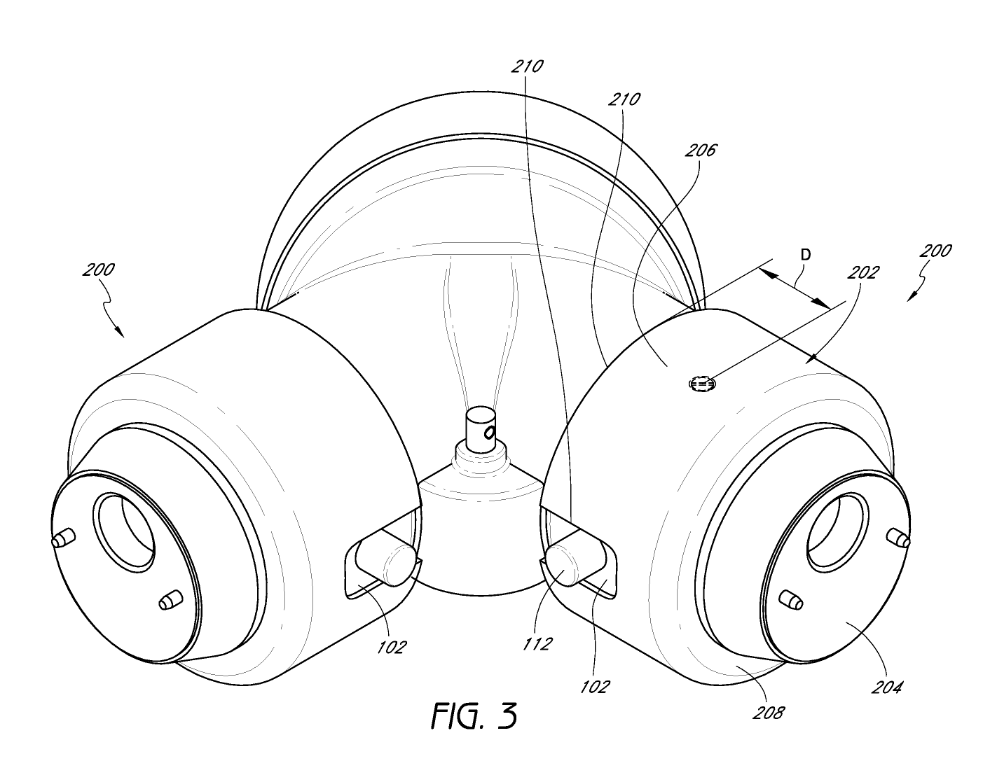

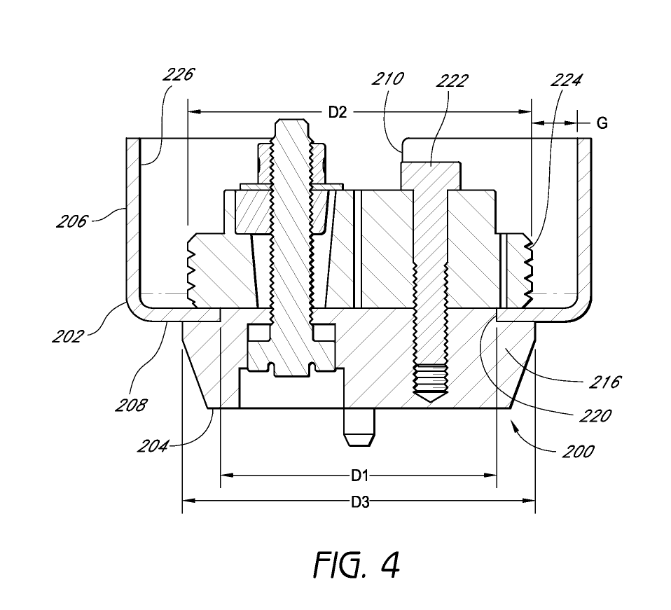

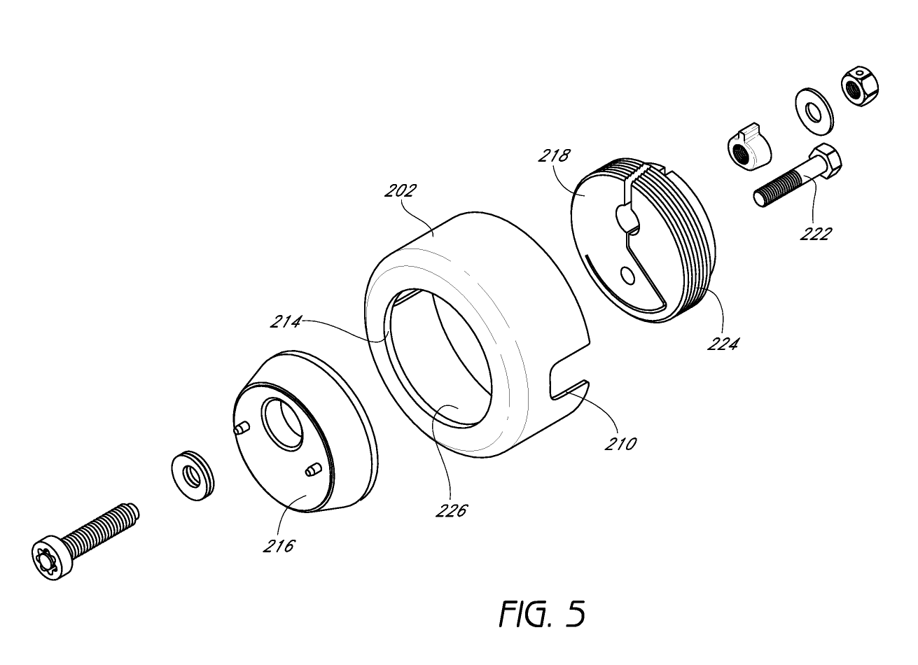

FIGS. 3-5 illustrate a swivel protection device 200 that is arranged and configured in accordance with certain features, aspects and advantages of the present invention. As illustrated, the swivel protection device 200 can be installed over at least a portion of the swivel 102 of the FDC. In some configurations, the swivel protection device 200 can cover substantially all of the exposed surfaces of the swivel 102. In other configurations, the swivel protection device 200 covers at least the screw plug 106 of the swivel 102.

The illustrated swivel protection device 200 generally comprises a cup-like enclosure 202. The enclosure 202 can be secured in place on the FDC with a locking plug 204, such as that disclosed in U.S. Pat. No. 6,487,882, issued on De. 3, 2002, which is hereby incorporated by reference in its entirety and specifically with regard to the construction of, and method of using, the locking plug 204. As will be explained, the locking plug 204 can be used to secure the enclosure 202 in position over top of the screw plug 106 of the swivel 102.

The enclosure 202 comprises at least one side wall 206 and an end wall 208. Other configurations are possible. For example, more than one side wall 206 can be used in some configurations. In addition, in some configurations, the side wall 206 extends around only a portion of the circumference of the swivel 102 and one or more than one such side wall 206 can be used.

Preferably, the at least one side wall 206 extends around the full circumference and comprises one or more cutouts, openings or recesses 210. The cutouts 210 accommodate two pin lugs 112 that extend outward from the sidewall of the swivel 102. In some configurations, the cutouts 210 can be replaced by embossments or the like that cover the pin lugs 112. Other configurations also are possible.

As explained above, the enclosure 202 also preferably comprises the end wall 208. The end wall 208 preferably defines an opening 214 though which a portion of the plug 204 can extend into the opening of the swivel 102. Preferably, the opening has a smaller inner diameter D1 than an outer diameter of the plug 204 on both sides of the end wall 208. In other words the inner diameter D1 of the opening 220 is less than the largest outer diameter D2 of the plug 204 and the largest outer diameter D3 of the face plate D3. While expressed in terms of diameters, other shapes can be used for one or all of the components such that the dimension is not a diameter but another form of cross dimension.

In some configurations, the end wall 208 has a sufficient thickness to limit any axial movement of the enclosure 202 relative to the plug 204 to a range of less than a distance D between the opposite end 210 of the at least one side wall 206 and the screw plug of the FDC. In other words, any axial movement of the installed enclosure 202 preferably is less than the amount of movement that will allow access to the screw plug of the FDC.

In a preferred configuration, the plug 204 comprises a face plate 216 and a plug body 218. At least a portion of the end wall 208 of the enclosure 202 is positioned between the plug body 218 and the face plate 216. The end wall 208 is capable of rotational movement relative to the plug 204 such that the enclosure 202 can remain stationary while the plug 204 is rotated into position within the swivel 102 or vice versa.

In the illustrated configuration, the face plate 216 comprises a step 220 that receives the opening 214 of the enclosure. In some embodiments, the plug body 218 can comprise the step 220. Other configurations also are possible, including those without the step 220. With the end wall 208 positioned between the plug body 218 and the face plate 216, a threaded member 222 (e.g., a bolt) can be used to secure the plug body 218 to the face plate 216, which in turn secures the enclosure 202 in position relative to the plug 204.

Preferably, the plug body 218 comprises an outer sidewall 224. The outer sidewall 224 generally is threaded. Other configurations also can be used keeping in mind the desire to contact inner threads of the swivel 102 without deforming the inner threads. An inner surface 226 of the at least one sidewall 206 preferably extends generally parallel to, and is spaced apart from, the outer sidewall 224 of the plug body 218. In the illustrated embodiment, a gap G is defined between the outer sidewall 224 and the plug body 218. The gap G is sufficiently large to accommodate the sidewall of the swivel 102. Preferably, the gap G also is not overly large compared to the sidewall of the swivel 102 such that the space defined between the inner surface 226 of the enclosure and the outer surface of the swivel 102 does not leave open significant room for prying or insertion of other tools between the enclosure 202 and the swivel 102.

To install the device 200, first the enclosure 202 is placed over the unprotected FDC 100 with the swivel 102 being generally enclosed by the at least one side wall 206 and threads of the plug body 218 resting in contact with threads of the swivel 102. The pin lugs 112 of the swivel 102 can be received within the cutouts 210 of the at least one side wall 206. With the enclosure 202 placed over the swivel, the locking plug 204 can be threaded into the opening of the FDC and then locked in place. Removal can be performed by unthreading the locking plug 204 and then removing the device 200. Other methods also can be used. For example, in some embodiments, the plug body 218 can be collapsed downward to a sufficient degree that it can be inserted into the swivel without significant threading and/or removed from the swivel without significant unthreading.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A swivel protection device for assembly onto a fire department connection swivel, the device comprising an enclosure and a locking plug, the locking plug being adapted to lock within an opening of the fire department connection, the locking plug having an outside diameter, the enclosure comprising at least one side wall, the at least one side wall adapted to extend over an outer surface of the fire department connection, the at least one side wall connected to an end wall, the end wall comprising an opening having a cross dimension that is smaller than the outside diameter of the locking plug.

2. The swivel protection device of claim 1, wherein the at least one side wall comprises an opening sized and configured to receive a pin lug of the fire department connection.

3. The swivel protection device of claim 1, wherein the at least one side wall is sized and configured to cover a threaded plug of the fire department connection.

4. The swivel protection device of claim 1, wherein the locking plug comprises a face plate and a plug body, the end wall of the enclosure being positioned between the face plate and the plug body.

5. The swivel protection device of claim 4, wherein the enclosure is capable of substantially free rotational movement relative to the locking plug.

6. A swivel protection device, the swivel protection device comprising a locking plug and an enclosure, the locking plug comprising a face plate and a plug member, the enclosure comprising an end wall and a side wall, the end wall comprising an opening, a portion of the locking plug extending through the opening, the end wall being positioned between at least a portion of the face plate and at least a portion of the plug member such that the end wall is captured between the face plate and the plug member, the enclosure being capable of rotational movement relative to the plug member, the plug member comprising an outer surface and the sidewall of the enclosure comprising an inner surface, the inner surface and the outer surface being spaced apart by a distance sufficiently large to accommodate a sidewall of a swivel.

7. The swivel protection device of claim 6, wherein the opening in the enclosure comprises a first largest inner dimension, the face plate comprising a first smallest outer dimension and the plug member comprising a second smallest outer dimension, the first largest inner dimension being smaller than the first and second smallest outer dimensions such that the end wall of the enclosure is captured between the face plate and the plug member.

8. The swivel protection device of claim 6, wherein the face plate is coupled to the plug member.

9. The swivel protection device of claim 8, wherein the face plate is coupled to the plug member with a threaded member that does not contact the enclosure.

10. The swivel protection device of claim 6, wherein the sidewall of the enclosure comprises at least two cutouts that are adapted to receive lugs of the swivel.

11. A method of installing a swivel protection device, the method comprising inserting a plug portion of a device into an opening of a swivel while sliding an enclosure portion of the device over an outer side surface of the swivel, threading the plug portion into the swivel, and locking the plug portion within the swivel.
